(19) United States
(12) Patent Application Publication
(10) Pub. No.: US 2025/0269622 A1
(43) Pub. Date: Aug. 28, 2025

(54) Wallboard Assembly Having Enhanced Fire Resistance

(71) Applicant: Gold Bond Building Products, LLC, Charlotte, NC (US)

(72) Inventors: Stephen A. Cusa, Downingtown, PA (US); Mark Chapman, Indian Land, SC (US)

(21) Appl. No.: 19/063,479

(22) Filed: Feb. 26, 2025

Related U.S. Application Data
(60) Provisional application No. 63/558,880, filed on Feb. 28, 2024.

(51) Int. Cl. B32B 3/06; B32B 13/04; C04B 111/00

(52) U.S. Cl. CPC B32B 3/06; B32B 13/04; B32B 2307/3065; B32B 2607/00; C04B 2111/0062

(57) ABSTRACT

The present invention is directed to wallboard assemblies containing a gypsum panel and a method of making such wallboard assemblies. In one embodiment, the wallboard assembly comprises a gypsum panel containing a gypsum core and at least one facing material. The wallboard assembly and/or the gypsum panel may be fire resistant. The methods of the present invention are directed to making the aforementioned wallboard assemblies.

### RELATED APPLICATIONS

The present application is based upon and claims priority to U.S. Provisional Patent Application Ser. No. 63/558,880, having a filing date of Feb. 28, 2024, which is incorporated herein by reference in its entirety.

### BACKGROUND OF THE INVENTION

A building is typically constructed with walls having a frame comprising vertically oriented studs connected by horizontally oriented top and bottom plates or tracks. The walls often include one or more gypsum wallboards fastened to the studs and/or plates on one side or both sides of the frame or, particularly for exterior walls, one or more gypsum wallboards fastened to the studs and/or plates on one side of the frame with a non-gypsum-based sheathing attached to an exterior side of the frame. A ceiling of the building may also include one or more gypsum wallboards oriented horizontally and fastened to joists, studs, or other structural members extending horizontally in the building.

Notably, an important consideration and characteristic of a wallboard is the fire resistance of the wallboard and the corresponding assembly. In general, a wide range of technologies both in processing and chemistry have improved the fire resistance performance of wallboards in recent times. However, the fire resistance performance of wallboards can still be improved with further innovations.

Therefore, there exists a need for a wallboard and wallboard assembly having improved fire resistance. In particular, a need exists for providing a wallboard and wallboard assembly with enhanced fire resistance properties when exposed to high temperatures.

### SUMMARY OF THE INVENTION

Aspects and advantages of the invention will be set forth in part in the following description, or may be obvious from the description, or may be learned through practice of the invention.

In accordance with one aspect of the present invention, a wallboard assembly is disclosed. The wallboard assembly comprises: a gypsum panel comprising a gypsum core and at least one facing material; and two or more fasteners, the two or more fasteners comprising one or more field fasteners and one or more perimeter fasteners, wherein at least two adjacent fasteners of the two or more fasteners are spaced from each other by a distance of greater than 12 inches on center; wherein the wallboard assembly has a fire rating of at least about 50 minutes when tested in accordance with the time-temperature curve of ASTM standard E119-16a and at least one of V438, U465, V488, or W469 Underwriters Laboratories, Inc. assemblies.

In some aspects, at least two adjacent fasteners of the two or more fasteners are spaced from each other by a distance of about 14 inches on center or more. In some aspects, at least two adjacent fasteners of the two or more fasteners are spaced from each other by a distance of about 16 inches on center or more.

In some aspects, at least one perimeter fastener of the one or more perimeter fasteners perpendicularly corresponds to at least one field fastener of the one or more field fasteners.

In some aspects, at least one field fastener and the perpendicularly corresponding perimeter fastener are adjacent and are spaced from each other by a distance of about 12 inches on center or more. In some aspects, at least one field fastener and the perpendicularly corresponding perimeter fastener are adjacent and are spaced from each other by a distance of about 14 inches on center or more.

In some aspects, the one or more field fasteners are spaced at regular intervals. In some aspects, the one or more field fasteners form one or more field fastener rows, the one or more field fastener rows being in-line. In some aspects, the one or more perimeter fasteners form one or more perimeter fastener rows, the one or more perimeter fastener rows being in-line.

In some aspects, the one or more field fasteners form one or more field fastener rows, the one or more field fastener rows being in-line, wherein the one or more perimeter fasteners form one or more perimeter fastener rows, the one or more perimeter fastener rows being in-line. In some aspects, the one or more field fastener rows and the one or more perimeter fastener rows are spaced by a distance of about 14 inches or more. In some aspects, at least one perimeter fastener row of the one or more perimeter fastener rows and a first field fastener row of the one or more field fastener rows are spaced by a distance of 14 inches or more, wherein the at least one perimeter fastener row and a second field fastener row of the one or more field fastener rows are spaced by a distance of about 16 inches or more. In some aspects, the first field fastener row and the second field fastener row are spaced by a distance of about 4 inches or more.

In some aspects, wherein the one or more perimeter fasteners form two perimeter fastener rows, the two perimeter fastener rows including a first perimeter fastener row and a second perimeter fastener row. In some aspects, the first perimeter fastener row and the second perimeter fastener row are spaced by a distance of about 24 inches or more. In some aspects, the first perimeter fastener row and the second perimeter fastener row are spaced by a distance of about 32 inches or more.

In accordance with one aspect of the present invention, a wallboard assembly is disclosed. The wallboard assembly comprises: a gypsum panel comprising a gypsum core and at least one facing material; and two or more fasteners, the two or more fasteners comprising one or more field fasteners and one or more perimeter fasteners, the one or more field fasteners and the one or more perimeter fasteners having on center values within a 12 inch on center range or less, wherein at least two adjacent fasteners of the two or more fasteners are spaced from each other by a distance of greater than 12 inches on center; wherein the wallboard assembly has a fire rating of at least about 50 minutes when tested in accordance with the time-temperature curve of ASTM standard E119-16a and at least one of V438, U465, V488, or W469 Underwriters Laboratories, Inc. assemblies.

In accordance with one aspect of the present invention, a wallboard assembly is disclosed. The wallboard assembly comprises: a gypsum panel comprising a gypsum core and at least one facing material; and two or more fasteners, the two or more fasteners comprising one or more field fasteners and one or more perimeter fasteners, wherein at least one field fastener is spaced from all of the perimeter fasteners by a distance of greater than 12 inches; wherein the wallboard assembly has a fire rating of at least about 50 minutes when tested in accordance with the time-temperature curve of ASTM standard E119-16a and at least one of V438, U465, V488, or W469 Underwriters Laboratories, Inc. assemblies.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a front view of one embodiment of a wallboard assembly in accordance with aspects of the present subject matter;

FIG. 2 illustrates a front view of one embodiment of a wallboard assembly in accordance with aspects of the present subject matter;

FIG. 3 illustrates a front view of one embodiment of a wallboard assembly in accordance with aspects of the present subject matter;

FIG. 4 illustrates a front view of one embodiment of a wallboard assembly in accordance with aspects of the present subject matter;

FIG. 5 illustrates a front view of one embodiment of a wallboard assembly in accordance with aspects of the present subject matter; and

FIG. 6 illustrates a top view of one embodiment of a wallboard assembly in accordance with aspects of the present subject matter.

Repeat use of reference characters in the present specification and drawings is intended to represent the same or analogous features or elements of the present invention.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present invention is directed to a fire resistant wallboard assembly and a method of making such wallboard assembly. In particular, the fire resistant wallboard assembly can include one or more wallboards (e.g., a gypsum panel), one or more fasteners, one or more grid markings, one or more studs, one or more joists, and/or one or more rafters. The present inventors have discovered that the fire resistant wallboard assembly disclosed herein can have various benefits due to the configuration and properties of the assembly. For instance, the fire resistant wallboard assembly disclosed herein may have one or more fasteners positioned such that the fire resistance properties of the wallboard assembly are improved and/or maintained with fewer fasteners. Notably, the spacing of the one or more fasteners may result in a wallboard assembly utilizing less fasteners, which may decrease cost and/or labor time.

As used in the present disclosure, the term “wallboard,” generally refers to any panel, sheet, or planar structure, either uniform or formed by connected portions or pieces, that is constructed to at least partially establish one or more physical boundaries. Generally, a wallboard may be fastened or affixed to an existing, installed, or otherwise established wall or ceiling structure. The existing, installed, or otherwise established wall or ceiling structure may comprise materials that may include, as non-limiting examples, gypsum, stone, ceramic, cement, wood, composite, or metal materials. The installed wallboard assembly may form part of a building structure, such as a wall or ceiling.

It should be understood that throughout the entirety of this specification, each numerical value (e.g., weight percentage, concentration) disclosed should be read as modified by the term “about”, unless already expressly so modified, and then read again as not to be so modified. For instance, a value of “100” is to be understood as disclosing “100” and “about 100”. Further, it should be understood that throughout the entirety of this specification, when a numerical range (e.g., weight percentage, concentration) is described, any and every amount of the range, including the end points and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value. It should be understood that, unless stated otherwise, any standard listed herein (e.g., ASTM) is the most recent version available as of the latest revision year. Notably, some aspects of the present disclosure may omit one or more of the features disclosed herein.

Notably, a wallboard assembly formed in accordance with the present disclosure may conform or be configured to the specification of Underwriters Laboratories, Inc. (UL®) assemblies, such as V438, U465, V488, W469, or a combination thereof. For a fire test, the face of one side of the assembly can be exposed to increasing temperatures for a period of time in accordance with a heating curve, such as those discussed in ASTM E119-16a. The temperatures proximate the heated side and the temperatures at the surface of the unheated side of the assembly are monitored during the tests to evaluate the temperatures experienced by the exposed side and the heat transmitted through the assembly to the unexposed side.

In one embodiment, a wallboard assembly formed according to the present disclosure and in accordance with the specification of a V438 assembly may have a fire rating of at least about 50 minutes, such as at least about 52.5 minutes, such as at least about 55 minutes, such as at least about 55.5 minutes, such as at least about 56 minutes, such as at least about 56.5 minutes, such as at least about 57 minutes, such as at least about 57.5 minutes, such as at least about 58 minutes, such as at least about 58.5 minutes, such as at least about 59 minutes, such as at least about 59.5 minutes, such as at least about 60 minutes, such as at least about 60.5 minutes, such as at least about 61 minutes, such as at least about 61.5 minutes, such as at least about 62 minutes, such as at least about 62.5 minutes, such as at least about 63 minutes, such as at least about 63.5 minutes, such as at least about 64 minutes, such as at least about 64.5 minutes, such as at least about 65 minutes when heated in accordance with the time-temperature curve of ASTM standard E119-16a. The fire rating may be about 75 minutes or less, such as about 73 minutes or less, such as about 71 minutes or less, such as about 70 minutes or less, such as about 69 minutes or less, such as about 68 minutes or less, such as about 67 minutes or less, such as about 66 minutes or less, such as about 65 minutes or less, such as about 64 minutes or less, such as about 63 minutes or less, such as about 62 minutes or less, such as about 61 minutes or less, such as about 60 minutes or less, such as about 59.5 minutes or less, such as about 59 minutes or less, such as about 58.5 minutes or less, such as about 58 minutes or less, such as about 57.5 minutes or less, such as about 57 minutes or less, such as about 56.5 minutes or less, such as about 56 minutes or less, such as about 55.5 minutes or less, such as about 55 minutes or less, such as about 52.5 minutes or less when heated in accordance with the time-temperature curve of ASTM standard E119-16a.

In one embodiment, a wallboard assembly formed according to the present disclosure and in accordance with the specification of a U465 assembly may have a fire rating of at least about 50 minutes, such as at least about 52.5 minutes, such as at least about 55 minutes, such as at least about 55.5 minutes, such as at least about 56 minutes, such as at least about 56.5 minutes, such as at least about 57 minutes, such as at least about 57.5 minutes, such as at least about 58 minutes, such as at least about 58.5 minutes, such as at least about 59 minutes, such as at least about 59.5 minutes, such as at least about 60 minutes, such as at least about 60.5 minutes, such as at least about 61 minutes, such as at least about 61.5 minutes, such as at least about 62 minutes, such as at least about 62.5 minutes, such as at least about 63 minutes, such as at least about 63.5 minutes, such as at least about 64 minutes, such as at least about 64.5 minutes, such as at least about 65 minutes when heated in accordance with the time-temperature curve of ASTM standard E119-16a. The fire rating may be about 75 minutes or less, such as about 73 minutes or less, such as about 71 minutes or less, such as about 70 minutes or less, such as about 69 minutes or less, such as about 68 minutes or less, such as about 67 minutes or less, such as about 66 minutes or less, such as about 65 minutes or less, such as about 64 minutes or less, such as about 63 minutes or less, such as about 62 minutes or less, such as about 61 minutes or less, such as about 60 minutes or less, such as about 59.5 minutes or less, such as about 59 minutes or less, such as about 58.5 minutes or less, such as about 58 minutes or less, such as about 57.5 minutes or less, such as about 57 minutes or less, such as about 56.5 minutes or less, such as about 56 minutes or less, such as about 55.5 minutes or less, such as about 55 minutes or less, such as about 52.5 minutes or less when heated in accordance with the time-temperature curve of ASTM standard E119-16a.

In one embodiment, a wallboard assembly formed according to the present disclosure and in accordance with the specification of a V488 assembly may have a fire rating of at least about 50 minutes, such as at least about 52.5 minutes, such as at least about 55 minutes, such as at least about 55.5 minutes, such as at least about 56 minutes, such as at least about 56.5 minutes, such as at least about 57 minutes, such as at least about 57.5 minutes, such as at least about 58 minutes, such as at least about 58.5 minutes, such as at least about 59 minutes, such as at least about 59.5 minutes, such as at least about 60 minutes, such as at least about 60.5 minutes, such as at least about 61 minutes, such as at least about 61.5 minutes, such as at least about 62 minutes, such as at least about 62.5 minutes, such as at least about 63 minutes, such as at least about 63.5 minutes, such as at least about 64 minutes, such as at least about 64.5 minutes, such as at least about 65 minutes when heated in accordance with the time-temperature curve of ASTM standard E119-16a. The fire rating may be about 75 minutes or less, such as about 73 minutes or less, such as about 71 minutes or less, such as about 70 minutes or less, such as about 69 minutes or less, such as about 68 minutes or less, such as about 67 minutes or less, such as about 66 minutes or less, such as about 65 minutes or less, such as about 64 minutes or less, such as about 63 minutes or less, such as about 62 minutes or less, such as about 61 minutes or less, such as about 60 minutes or less, such as about 59.5 minutes or less, such as about 59 minutes or less, such as about 58.5 minutes or less, such as about 58 minutes or less, such as about 57.5 minutes or less, such as about 57 minutes or less, such as about 56.5 minutes or less, such as about 56 minutes or less, such as about 55.5 minutes or less, such as about 55 minutes or less, such as about 52.5 minutes or less when heated in accordance with the time-temperature curve of ASTM standard E119-16a.

In one embodiment, a wallboard assembly formed according to the present disclosure and in accordance with the specification of a W469 assembly may have a fire rating of at least about 50 minutes, such as at least about 52.5 minutes, such as at least about 55 minutes, such as at least about 55.5 minutes, such as at least about 56 minutes, such as at least about 56.5 minutes, such as at least about 57 minutes, such as at least about 57.5 minutes, such as at least about 58 minutes, such as at least about 58.5 minutes, such as at least about 59 minutes, such as at least about 59.5 minutes, such as at least about 60 minutes, such as at least about 60.5 minutes, such as at least about 61 minutes, such as at least about 61.5 minutes, such as at least about 62 minutes, such as at least about 62.5 minutes, such as at least about 63 minutes, such as at least about 63.5 minutes, such as at least about 64 minutes, such as at least about 64.5 minutes, such as at least about 65 minutes when heated in accordance with the time-temperature curve of ASTM standard E119-16a. The fire rating may be about 75 minutes or less, such as about 73 minutes or less, such as about 71 minutes or less, such as about 70 minutes or less, such as about 69 minutes or less, such as about 68 minutes or less, such as about 67 minutes or less, such as about 66 minutes or less, such as about 65 minutes or less, such as about 64 minutes or less, such as about 63 minutes or less, such as about 62 minutes or less, such as about 61 minutes or less, such as about 60 minutes or less, such as about 59.5 minutes or less, such as about 59 minutes or less, such as about 58.5 minutes or less, such as about 58 minutes or less, such as about 57.5 minutes or less, such as about 57 minutes or less, such as about 56.5 minutes or less, such as about 56 minutes or less, such as about 55.5 minutes or less, such as about 55 minutes or less, such as about 52.5 minutes or less when heated in accordance with the time-temperature curve of ASTM standard E119-16a.

As previously disclosed herein, a wallboard assembly and/or wallboard may include one or more grid markings. For instance, the wallboard assembly and/or any component thereof may include grid markings, such as the grid markings described in U.S. Pat. Nos. 7,151,553 and 7,220,329, which are both incorporated herein by reference in their entirety. Generally, one or more grid markings may be present on the surface of one or more facing materials of a wallboard (e.g., a gypsum panel) and/or wallboard assembly. Notably, in one aspect, one or more facing materials of a wallboard (e.g., a gypsum panel) and/or wallboard assembly may be free of grid markings.

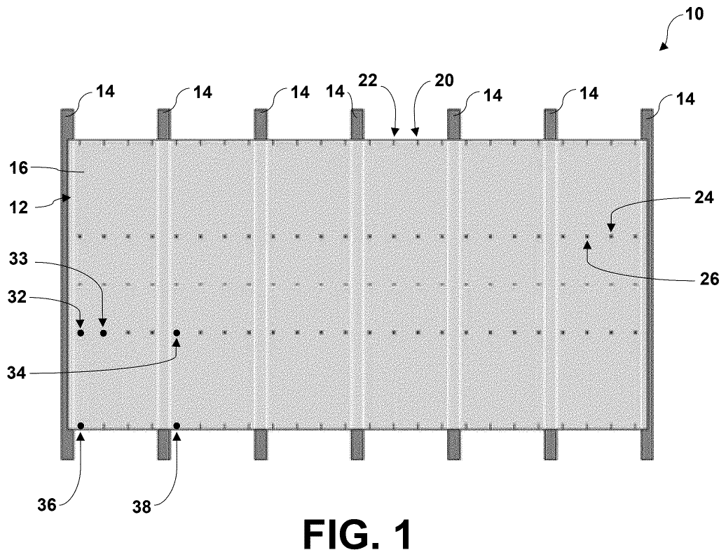

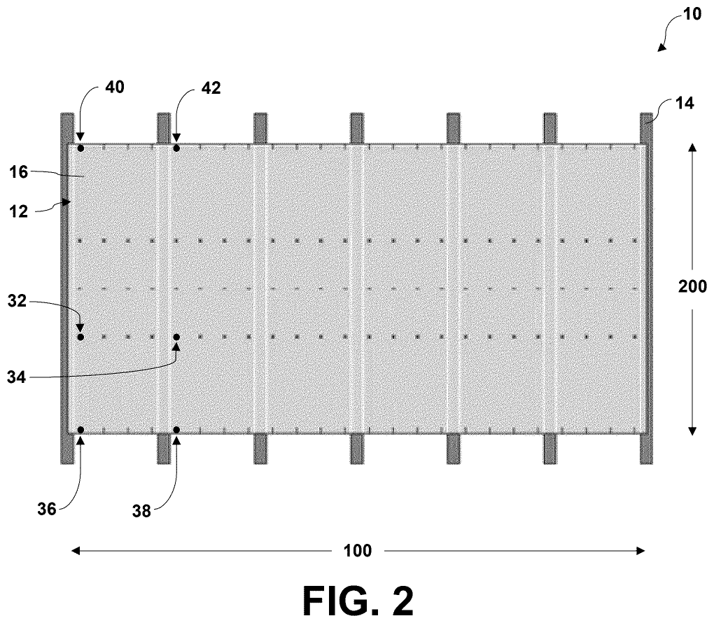

As illustrated in FIG. 1, one embodiment of a wallboard assembly 10 may include a wallboard 12, one or more studs 14, and one or more grid markings 20, 22, 24, 26. In FIG. 1, and FIGS. 2-5, the grid markings are spaced at 4 inch intervals in the field and along the perimeter of the wallboard 12. For instance, grid markings 20 and 22 are exemplary of grid markings spaced about 4 inches from each other along the perimeter of the wallboard 12. Further, for instance, grid markings 24 and 26 are exemplary of grid markings spaced about 4 inches from each other in the field of the wallboard 12. As also illustrated in FIG. 1, a wallboard 12 may include a facing material 16 having grid markings 20, 22, 24, and 26 present thereon.

Generally, the one or more grid markings may provide a visual indication of where one or more fasteners should be positioned. It should be understood that the one or more grid markings may be positioned where the one or more fasteners (e.g., field fasteners, perimeter fasteners) are positioned. Notably, the one or more grid markings may have one or more, such as any, of the features of one or more fasteners disclosed herein. For instance, the one or more grid markings may have one or more of the positional features of one or more fasteners, such as any of the positional features disclosed herein. For instance, the one or more grid markings may be spaced from one another by a distance of greater than about 12 inches on center, may be in-line, and/or may form one or more rows. Notably, the one or more grid markings may be referred to as one or more field grid markings and/or one or more perimeter grid markings. The one or more field grid markings and/or the one or more perimeter grid markings may have any of the positional features of the one or more field fasteners and/or one or more perimeter fasteners disclosed herein.

As previously disclosed herein, the wallboard assembly may include one or more fasteners. In general, the one or more fasteners may include nails, screws, laminating screws, bolts, or a combination thereof. The one or more fasteners may be utilized to fasten a first wallboard (e.g., a gypsum panel) to a structural support (e.g. one or more studs, one or more joists, and/or one or more rafters) and/or a second wallboard (e.g., an existing or installed wallboard). The one or more fasteners may be utilized to increase the probability that a wallboard (e.g., a gypsum panel) remains attached or fastened to a structural support and/or a second wallboard in order to protect the overall wallboard assembly during exposure to heat and/or a fire. In general, an increase in the amount of fasteners may increase the probability that a first wallboard (e.g., a gypsum panel) remains attached or fastened to a structural support and/or a second wallboard. However, the continuity of a wallboard (e.g., gypsum panel) and/or a component thereof (e.g., a facing material) may become interrupted by fastener deformations, which include holes, punctures, cracks, cuts, perforations, or the like caused by fasteners used to position a wallboard (e.g., a gypsum panel) in place. The fastener deformations may affect wallboard components, such as one or more facing materials of a wallboard (e.g., a gypsum panel), that may provide a barrier to heat, smoke, and/or fire. Further, such fastener deformations may expose a component of a wallboard, such as a gypsum core, to high temperatures and/or fire, which may lead to the failure of a wallboard assembly. In particular, when a gypsum panel is utilized in a wallboard assembly, the exposure of the gypsum core to high temperatures and/or a fire may result in increased calcination of the gypsum of the gypsum core. The increased calcination of the gypsum may lead to gypsum panel fall-off and/or may decrease the time to failure as defined under ASTM E119-16a. Therefore, the amount and configuration of the one or more fasteners is an important consideration when forming the wallboard assembly. Notably, the spacing of one or more fasteners of a wallboard assembly formed in accordance with the present disclosure may result in a wallboard assembly having acoustical benefits, such as reduced sound transmission, may result in cleaner job sites, and/or may result in enhanced indoor air quality due to less finishing and sanding.

In general, fastener holding capabilities and/or overall wallboard quality may be measured, for example, using a nail pull resistance test according to ASTM C473-19 and/or ASTM C1396-17.

Generally, an enhanced fastener spacing may be utilized to improve the fire resistance properties of the wallboard assembly. Traditionally, the fastener spacing utilized to pass UL® assembly tests, including V438, U465, V488, and W469, is about 8 inches on center for the entire perimeter of each wallboard and about 12 inches on center for the field. It should be understood that one way to distinguish the perimeter fasteners from the field fasteners is that the perimeter fasteners are along the perimeter or edge of the wallboard assembly on opposing sides of the width 200 of the wallboard 12, as illustrated in FIG. 2. The field fasteners are the other fasteners of the wallboard assembly. In this respect, FIG. 2 illustrates one aspect including perimeter fasteners 36, 38, 40, and 42 and field fasteners 32 and 34.

As used herein, the term “on center” (“o.c.”) refers to the measurement from the center of one fastener to the center of the next fastener. Notably, FIG. 1 illustrates a fastener spacing for the field between two field fasteners 32, 34 of about 16 inches on center and further illustrates a fastener spacing for the perimeter between two perimeter fasteners 36, 38 of about 16 inches on center.

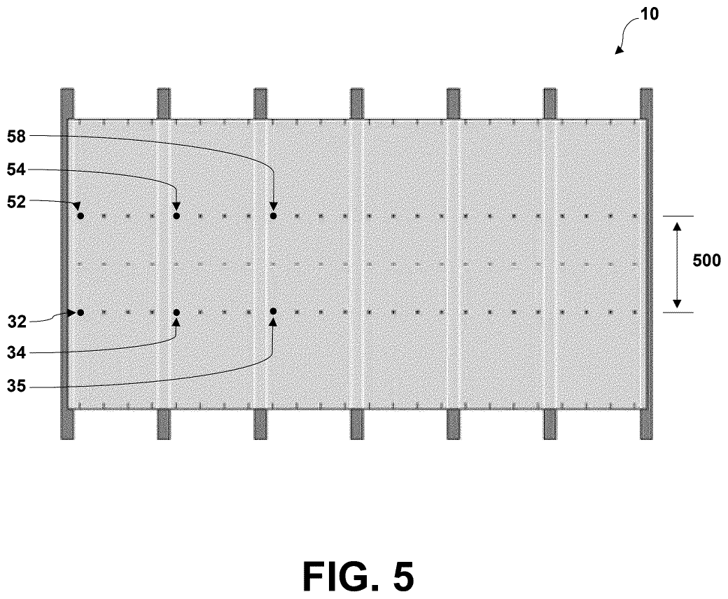

As used herein, with respect to fasteners, the term “adjacent fastener”, or similar (e.g., adjacent perimeter fastener, adjacent field fastener), refers to a fastener that is adjacent to another fastener via the width or the length of a wallboard and/or wallboard assembly. For instance, in FIG. 1, field fastener 32 is adjacent to field fastener 33. Further, in FIG. 1, field fastener 32 is adjacent to perimeter fastener 36. In FIG. 1, field fastener 33 is not adjacent to perimeter fastener 36. Further, in FIG. 1, field fastener 34 and perimeter fastener 38 are adjacent. Additionally, in FIG. 5, field fasteners 34 and 54 are adjacent. Notably, in FIG. 1, perimeter fasteners 36 and 38 are not considered adjacent and field fasteners 32 and 34 are not considered adjacent.

Notably, two or more perimeter fasteners, such as two or more adjacent perimeter fasteners, of the perimeter of a wallboard (e.g., a first wallboard) of a wallboard assembly of the present disclosure may be spaced from one another by a distance of greater than about 12 inches on center, such as about 13 inches on center or more, such as about 14 inches on center or more, such as about 15 inches on center or more, such as about 16 inches on center or more, such as about 17 inches on center or more, such as about 18 inches on center or more, such as about 19 inches on center or more, such as about 20 inches on center or more, such as about 22 inches on center or more, such as about 24 inches on center or more. In general, two or more perimeter fasteners, such as two or more adjacent perimeter fasteners, of the perimeter of a wallboard (e.g., a first wallboard) of a wallboard assembly of the present disclosure may be spaced from one another by a distance of less than about 32 inches on center, such as about 30 inches on center or less, such as about 28 inches on center or less, such as about 26 inches on center or less, such as about 24 inches on center or less, such as about 22 inches on center or less, such as about 20 inches on center or less, such as about 19 inches on center or less, such as about 18 inches on center or less, such as about 17 inches on center or less, such as about 16 inches on center or less, such as about 15 inches on center or less, such as about 14 inches on center or less, such as about 13 inches on center or less. It should be understood that the aforementioned fastener spacing may be applicable to any number of fasteners, such as three fasteners. In this respect, in one aspect, a first perimeter fastener may be spaced from a second perimeter fastener by about 16 inches on center or more, and the second perimeter fastener may be spaced from a third perimeter fastener by about 16 inches on center or more. It should be understood that two or more adjacent perimeter fasteners may be along one edge of a wallboard.

Notably, two or more field fasteners, such as two or more adjacent field fasteners, of the field of a wallboard (e.g., a first wallboard) of a wallboard assembly of the present disclosure may be spaced from one another by a distance of greater than about 12 inches on center, such as about 13 inches on center or more, such as about 14 inches on center or more, such as about 15 inches on center or more, such as about 16 inches on center or more, such as about 17 inches on center or more, such as about 18 inches on center or more, such as about 19 inches on center or more, such as about 20 inches on center or more, such as about 22 inches on center or more, such as about 24 inches on center or more. In general, two or more field fasteners, such as two or more adjacent field fasteners, of the field of a wallboard (e.g., a first wallboard) of a wallboard assembly of the present disclosure may be spaced from one another by a distance of less than about 26 inches on center, such as about 24 inches on center or less, such as about 22 inches on center or less, such as about 20 inches on center or less, such as about 19 inches on center or less, such as about 18 inches on center or less, such as about 17 inches on center or less, such as about 16 inches on center or less, such as about 15 inches on center or less, such as about 14 inches on center or less, such as about 13 inches on center or less. It should be understood that the aforementioned fastener spacing may be applicable to any number of fasteners, such as three fasteners. In this respect, in one aspect, a first field fastener may be spaced from a second field fastener by about 16 inches on center or more, and the second field fastener may be spaced from a third field fastener by about 16 inches on center or more.

Notably, the fastener spacing for the perimeter of a wallboard (e.g., a first wallboard) of the wallboard assembly and the fastener spacing for the field of a wallboard of the wallboard assembly may have on center values within a 0.1 inch on center range or more, such as a 0.5 on center range or more, such as a 1 inch on center range or more, such as a 2 inch on center range or more, such as a 4 inch on center range or more, such as a 6 inch on center range or more, such as an 8 inch on center range or more, such as a 10 inch on center range or more, such as a 12 inch on center range or more. In general, the fastener spacing for the perimeter of a wallboard (e.g., a first wallboard) of the wallboard assembly and the fastener spacing for the field of a wallboard of the wallboard assembly may have on center values within a 12 inch on center range or less, such as a 10 inch on center range or less, such as a 8 inch on center range or less, such as a 6 inch on center range or less, such as a 4 inch on center range or less, such as a 2 inch on center range or less, such as a 1 inch on center range or less, such as a 0.5 inch on center range or less. For instance, in one aspect, the fastener spacing for the perimeter of a wallboard (e.g., a first wallboard) of the wallboard assembly may be 16 inches on center, while the fastener spacing for the field of a wallboard of the wallboard assembly may be 18 inches on center. In this respect, the fastener spacing for the perimeter of a wallboard (e.g., a first wallboard) of the wallboard assembly and the fastener spacing for the field of the wallboard of the wallboard assembly have on center values within a 2 inch on center range. Further, for instance, in one aspect, the fastener spacing for the perimeter of a wallboard (e.g., a first wallboard) of the wallboard assembly may be 14 inches on center, while the fastener spacing for the field of the wallboard of the wallboard assembly may be 18 inches on center. In this respect, the fastener spacing for the perimeter of a wallboard (e.g., a first wallboard) of the wallboard assembly and fastener spacing for the field of a wallboard of the wallboard assembly have on center values within a 4 inch on center range. Additionally, for instance, in one aspect, the fastener spacing for the perimeter of a wallboard (e.g., a first wallboard) of the wallboard assembly may be 14 inches on center, while the fastener spacing for the field of the wallboard of the wallboard assembly may be 26 inches on center. In this respect, the fastener spacing for the perimeter of a wallboard (e.g., a first wallboard) of the wallboard assembly and fastener spacing for the field of a wallboard of the wallboard assembly have on center values within a 12 inch on center range.

Generally, a wallboard assembly formed in accordance with the present disclosure may have an enhanced fastener spacing between a fastener in the field of a wallboard and at least one perpendicularly corresponding fastener along the perimeter of the wallboard. It should be understood that the distance between a fastener in the field of a wallboard and a perpendicularly corresponding fastener along the perimeter of the wallboard is determined by the distance between a fastener in the field of the wallboard and a perpendicularly corresponding perimeter fastener that is perpendicular to the length of a wallboard (e.g., gypsum panel) and/or wallboard assembly and that is in-line with the respective fastener in the field. Generally, two perimeter fasteners perpendicularly correspond to a fastener in the field. FIG. 2 illustrates one aspect of two fasteners 32 and 34 in the field and their two respective perpendicularly corresponding perimeter fasteners 36,40 and 38,42. It should be understood that for fastener 32, the perpendicularly corresponding perimeter fasteners are 36 and 40. Notably, fasteners 36 and 40 are perpendicular to the length 100 of a wallboard and/or wallboard assembly and are in-line with the respective fastener 32 in the field. Further, fastener 32 is adjacent to fastener 36. It should be understood that for fastener 34, the perpendicularly corresponding perimeter fasteners are 38 and 42. Notably, fasteners 38 and 42 are perpendicular to the length 100 of a wallboard and/or wallboard assembly and are in-line with the respective fastener 34 in the field.

In general, the distance between a field fastener and a perpendicularly corresponding perimeter fastener may be greater than about 12 inches on center, such as about 13 inches on center or more, such as about 14 inches on center or more, such as about 15 inches on center or more, such as about 16 inches on center or more, such as about 17 inches on center or more, such as about 18 inches on center or more, such as about 19 inches on center or more, such as about 20 inches on center or more, such as about 22 inches on center or more, such as about 24 inches on center or more. In general, the distance between a field fastener and a perpendicularly corresponding perimeter fastener may be less than about 26 inches on center, such as about 24 inches on center or less, such as about 22 inches on center or less, such as about 20 inches on center or less, such as about 19 inches on center or less, such as about 18 inches on center or less, such as about 17 inches on center or less, such as about 16 inches on center or less, such as about 15 inches on center or less, such as about 14 inches on center or less, such as about 13 inches on center or less.

In some aspects, the distance between at least one field fastener of the wallboard and one or more perimeter fasteners, such as all of the perimeter fasteners, may be greater than about 12 inches on center, such as about 13 inches on center or more, such as about 14 inches on center or more, such as about 15 inches on center or more, such as about 16 inches on center or more, such as about 17 inches on center or more, such as about 18 inches on center or more, such as about 19 inches on center or more, such as about 20 inches on center or more, such as about 22 inches on center or more, such as about 24 inches on center or more. In general, the distance between at least one field fastener of the wallboard and one or more perimeter fasteners, such as all of the perimeter fasteners, may be less than about 144 inches on center, such as about 120 inches on center or less, such as about 96 inches on center or less, such as about 60 inches on center or less, such as about 40 inches on center or less, such as about 26 inches on center or less, such as about 24 inches on center or less, such as about 22 inches on center or less, such as about 20 inches on center or less, such as about 19 inches on center or less, such as about 18 inches on center or less, such as about 17 inches on center or less, such as about 16 inches on center or less, such as about 15 inches on center or less, such as about 14 inches on center or less, such as about 13 inches on center or less. For instance, in one aspect, at least one field fastener may be distanced from all of the perimeter fasteners by a distance of about 16 inches on center or more. Further, in another aspect, all of the field fasteners may be distanced from all of the perimeter fasteners by a distance of about 16 inches on center or more.

In some aspects, the distance between at least one perimeter fastener of the wallboard and one or more field fasteners, such as all of the field fasteners, may be greater than about 12 inches on center, such as about 13 inches on center or more, such as about 14 inches on center or more, such as about 15 inches on center or more, such as about 16 inches on center or more, such as about 17 inches on center or more, such as about 18 inches on center or more, such as about 19 inches on center or more, such as about 20 inches on center or more, such as about 22 inches on center or more, such as about 24 inches on center or more. In general, the distance between at least one perimeter fastener of the wallboard and one or more field fasteners, such as all of the field fasteners, may be less than about 144 inches on center, such as about 120 inches on center or less, such as about 96 inches on center or less, such as about 60 inches on center or less, such as about 40 inches on center or less, such as about 26 inches on center or less, such as about 24 inches on center or less, such as about 22 inches on center or less, such as about 20 inches on center or less, such as about 19 inches on center or less, such as about 18 inches on center or less, such as about 17 inches on center or less, such as about 16 inches on center or less, such as about 15 inches on center or less, such as about 14 inches on center or less, such as about 13 inches on center or less. For instance, in one aspect, at least one perimeter fastener may be distanced from all of the field fasteners by a distance of about 16 inches on center or more. Further, in another aspect, all of the perimeter fasteners may be distanced from all of the field fasteners by a distance of about 16 inches on center or more.

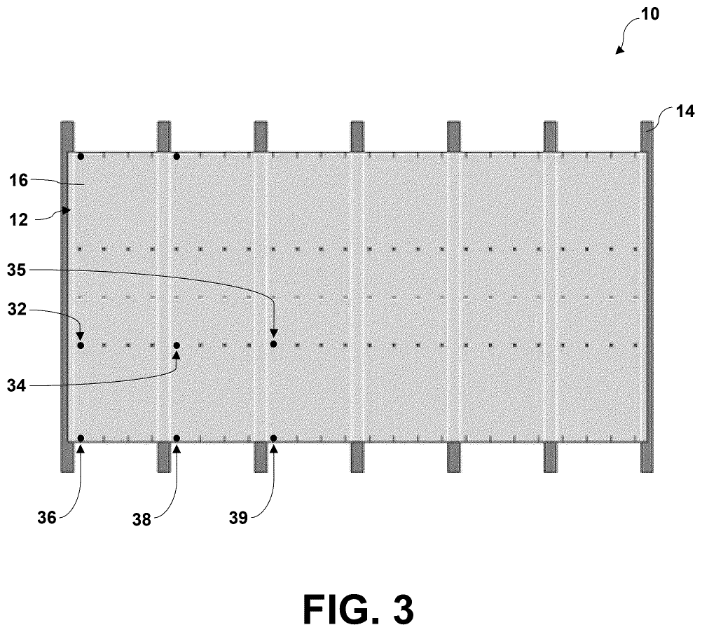

In general, three or more fasteners may be spaced at regular intervals. For instance, three or more fasteners may be spaced in the field at regular intervals of greater than about 12 inches on center, such as about 13 inches on center or more, such as about 14 inches on center or more, such as about 15 inches on center or more, such as about 16 inches on center or more, such as about 17 inches on center or more, such as about 18 inches on center or more, such as about 19 inches on center or more, such as about 20 inches on center or more, such as about 22 inches on center or more, such as about 24 inches on center or more. In general, three or more fasteners may be spaced in the field at regular intervals of less than about 26 inches on center, such as about 24 inches on center or less, such as about 22 inches on center or less, such as about 20 inches on center or less, such as about 19 inches on center or less, such as about 18 inches on center or less, such as about 17 inches on center or less, such as about 16 inches on center or less, such as about 15 inches on center or less, such as about 14 inches on center or less, such as about 13 inches on center or less. FIG. 3, for instance, illustrates three field fasteners 32, 34, and 35 spaced at a regular interval of 16 inches on center.

Further, for instance, three or more fasteners may be spaced along the perimeter at regular intervals such as about 12 inches on center or more, such as about 13 inches on center or more, such as about 14 inches on center or more, such as about 15 inches on center or more, such as about 16 inches on center or more, such as about 17 inches on center or more, such as about 18 inches on center or more, such as about 19 inches on center or more, such as about 20 inches on center or more, such as about 22 inches on center or more, such as about 24 inches on center or more. In general, three or more fasteners may be spaced along the perimeter at regular intervals of less than about 26 inches on center, such as about 24 inches on center or less, such as about 22 inches on center or less, such as about 20 inches on center or less, such as about 19 inches on center or less, such as about 18 inches on center or less, such as about 17 inches on center or less, such as about 16 inches on center or less, such as about 15 inches on center or less, such as about 14 inches on center or less, such as about 13 inches on center or less. FIG. 3, for instance, illustrates three perimeter fasteners 36, 38, and 39 spaced at a regular interval of 16 inches on center.

Notably, one or more fasteners (e.g., one or more field fasteners, one or more perimeter fasteners) may be positioned in-line. In general, one or more field fasteners may form one or more field fastener rows (e.g., two field fastener rows) on a wallboard. The one or more field fastener rows may be in-line. For instance, FIG. 3 illustrates three field fasteners 32, 34, and 35 forming a field fastener row that is in-line. In general, one or more perimeter fasteners may form one or more perimeter fastener rows (e.g., two perimeter fastener rows) on a wallboard. The one or more perimeter fastener rows may be in-line. For instance, FIG. 3 illustrates three perimeter fasteners 36, 38, and 39 forming a perimeter fastener row that is in-line.

In general, a wallboard assembly and/or wallboard may contain one or more field fastener rows and/or one or more perimeter fastener rows. For instance, a wallboard assembly and/or wallboard may contain two or more field fastener rows and/or two or more perimeter fastener rows. Generally, the distance between one or more field fastener rows and one or more perimeter fastener rows may range from about 14 inches or more to about 52 inches or less, including all increments of about 1 inch therebetween. For instance, the distance between a field fastener row and a perimeter fastener row may be about 14 inches or more, such as about 16 inches or more, such as about 20 inches or more, such as about 24 inches or more, such as about 28 inches or more, such as about 32 inches or more, such as about 36 inches or more, such as about 40 inches or more, such as about 44 inches or more. In general, the distance between a field fastener row and a perimeter fastener row may be about 52 inches or less, such as about 48 inches or less, such as about 44 inches or less, such as about 40 inches or less, such as about 36 inches or less, such as about 32 inches or less, such as about 28 inches or less, such as about 24 inches or less, such as about 20 inches or less, such as about 16 inches or less. It should be understood that one or more field fastener rows and one or more perimeter fastener rows may be adjacent. In this respect, the aforementioned distances between one or more field fastener rows and one or more perimeter fastener rows may refer to one or more field fastener rows and one or more perimeter fastener rows that are adjacent.

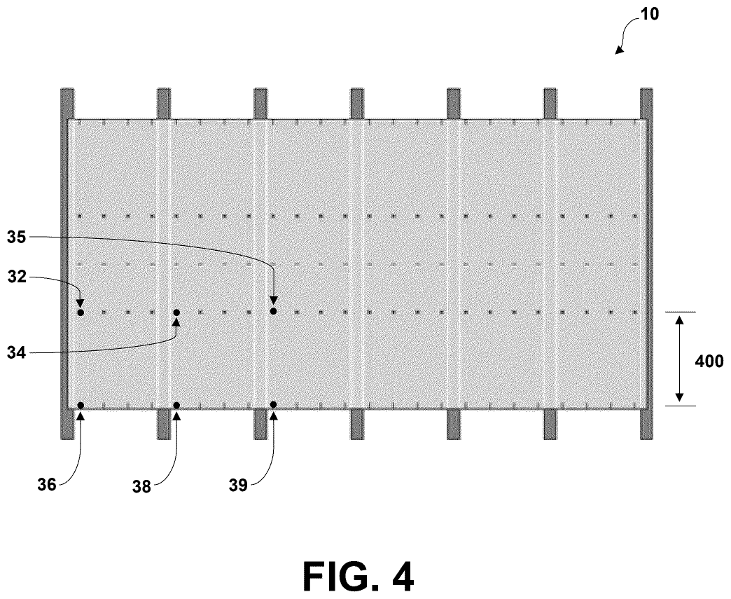

In one aspect, the distance between a perimeter fastener row and a first field fastener row may be about 12 inches or more, such as about 14 inches or more, such as about 16 inches or more, such as about 20 inches or more, such as about 24 inches or more. In general, the distance between a perimeter fastener row and a first field fastener row may be about 28 inches or less, such as about 24 inches or less, such as about 20 inches or less, such as about 16 inches or less. FIG. 4 illustrates one aspect of a wallboard assembly 10 having a distance 400 between a perimeter fastener row containing perimeter fasteners 36, 38, and 39 and a first field fastener row containing field fasteners 32, 34, and 35. It should be understood that a perimeter fastener row and a first field fastener row may be adjacent. In this respect, the aforementioned distances between a perimeter fastener row and a first field fastener row may refer to a perimeter fastener row and a first field fastener row that are adjacent.

In one aspect, the distance between a perimeter fastener row and a second field fastener row may be about 16 inches or more, such as about 20 inches or more, such as about 24 inches or more, such as about 28 inches or more, such as about 32 inches or more, such as about 36 inches or more, such as about 40 inches or more. In general, the distance between a perimeter fastener row and a second field fastener row may be about 48 inches or less, such as about 44 inches or less, such as about 40 inches or less, such as about 36 inches or less, such as about 32 inches or less, such as about 28 inches or less, such as about 24 inches or less, such as about 20 inches or less. It should be understood that a perimeter fastener row and a second field fastener row may be non-adjacent. In this respect, the aforementioned distances between a perimeter fastener row and a second field fastener row may refer to a perimeter fastener row and a second field fastener row that are non-adjacent.

In one aspect, the distance between a first field fastener row and a second field fastener row may be about 4 inches or more, such as about 6 inches or more, such as about 8 inches or more, such as about 10 inches or more, such as about 12 inches or more, such as about 16 inches or more, such as about 18 inches or more, such as about 20 inches or more. In general, the distance between a first field fastener row and a second field fastener row may be about 22 inches or less, such as about 20 inches or less, such as about 18 inches or less, such as about 16 inches or less, such as about 14 inches or less, such as about 12 inches or less, such as about 10 inches or less, such as about 8 inches or less, such as about 6 inches or less. FIG. 5 illustrates one aspect of a wallboard assembly 10 having a distance 500 between a first field fastener row containing field fasteners 32, 34, and 35 and a second field fastener row containing field fasteners 52, 54, and 58. It should be understood that a first field fastener row and a second field fastener row may be adjacent. In this respect, the aforementioned distances between a first field fastener row and a second field fastener row may refer to a first field fastener row and a second field fastener row that are adjacent.

In one aspect, the distance between a first perimeter fastener row and a second perimeter fastener row may be about 24 inches or more, such as about 28 inches or more, such as about 32 inches or more, such as about 36 inches or more, such as about 40 inches or more, such as about 44 inches or more, such as about 48 inches or more. In general, the distance between a first perimeter fastener row and a second perimeter fastener row may be about 60 inches or less, such as about 52 inches or less, such as about 48 inches or less, such as about 44 inches or less, such as about 40 inches or less, such as about 36 inches or less, such as about 32 inches or less.

In some aspects, the fastener spacing for the perimeter of a wallboard (e.g., a first wallboard) of the wallboard assembly and the fastener spacing for the field of a wallboard (e.g., a first wallboard) of the wallboard assembly of the present disclosure may have on center values that are the same. For instance, in one aspect, the fastener spacing for the perimeter of a wallboard (e.g., a first wallboard) of the wallboard assembly and the fastener spacing for the field of a wallboard of the wallboard assembly of the present disclosure may have on center values of about 16 inches.

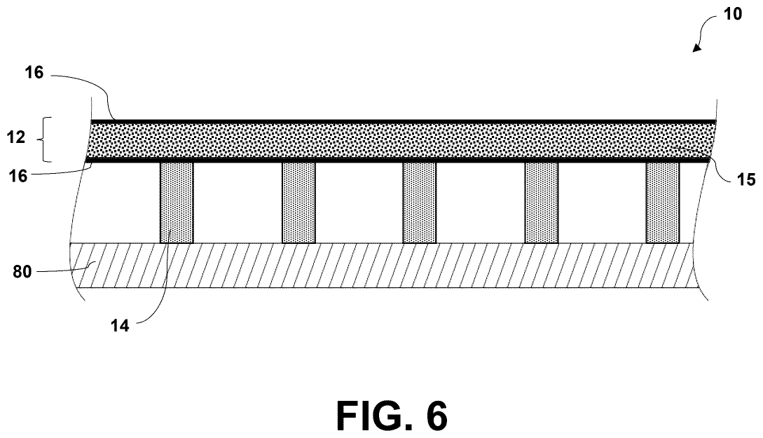

As illustrated in FIG. 6, a wallboard assembly 10 may include a wallboard 12 that is a gypsum panel that is fastened to one or more studs 14. The gypsum panel 12 may include two facing materials 16 and a gypsum core 15. In the embodiment shown in FIG. 6, the building structure is a vertically aligned building wallboard assembly 10, which optionally has a second installed wallboard 80 connected to an opposite side of the gypsum panel 12. The gypsum panel 12 and the second installed wallboard 80 may connected via one or more studs 14 of a wallboard assembly 10.

The present disclosure is also directed to a method of forming and/or constructing a wallboard assembly. The method may comprise forming or providing a first wallboard, such as a gypsum panel. The method may comprise providing an installed wallboard (e.g., a second wallboard) attached to a building wall or ceiling. The method may also include a further step of attaching, fastening, and/or affixing the first wallboard (e.g., a gypsum panel) to the installed or existing wallboard.

In some aspects, the method may comprise fastening and/or positioning two or more wallboards (e.g., two wallboards, three wallboards, four wallboards) on top of and/or adjacent to one another. In some aspects, the method may comprise positioning or fastening a first wallboard to a second wallboard. In this respect, the first wallboard may be adjacent to the second wallboard. Notably, a second wallboard formed in accordance with the present disclosure may have a perimeter fastener spacing and/or a field fastener spacing in accordance with any of the spacing configurations previously disclosed herein. In some aspects, a second wallboard may have the same perimeter fastener spacing and/or field fastener spacing as a first wallboard.

### Gypsum Panel

As previously disclosed herein, a wallboard assembly formed in accordance with the present disclosure may include a gypsum panel. In some aspects, a wallboard in accordance with the present disclosure may be a gypsum panel.

In general, a gypsum panel of the wallboard assembly may be manufactured into sizes, such as 48 inches by 96 inches, 48 inches by 120 inches, 48 inches by 144 inches, and so forth.

Generally, a gypsum panel may comprise a gypsum core and one or more facing materials.

Notably, the gypsum core may comprise calcium sulfate dihydrate. The gypsum used to make the gypsum core may be from a natural source, a synthetic source, and/or from reclaim and is thus not necessarily limited by the present invention. In general, the gypsum, in particular the calcium sulfate dihydrate, is present in the gypsum core in an amount of at least 50 wt. %, such as at least 60 wt. %, such as at least 70 wt. %, such as at least 80 wt. %, such as at least 90 wt. %, such as at least 95 wt. %, such as at least 98 wt. %, such as at least 99 wt. %. The gypsum is present in an amount of 100 wt. % or less, such as 99 wt. % or less, such as 98 wt. % or less, such as 95 wt. % or less, such as 90 wt. % or less based on the weight of the solids in the gypsum slurry. In one embodiment, the aforementioned weight percentages are based on the weight of the gypsum core. In another embodiment, the aforementioned weight percentages are based on the weight of the wallboard assembly.

In some aspects, the gypsum core may also comprise other cementitious materials. These cementitious materials may include calcium sulfate anhydrite, land plaster, cement, fly ash, or any combination thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material.

Generally, a gypsum panel and/or wallboard assembly formed in accordance with the present disclosure may have one or more fire resistance compositions applied (e.g., sprayed) to and/or incorporated in any component of a gypsum panel and/or wallboard assembly (e.g., a gypsum core, a gypsum core layer, a facing material) at any time of the process disclosed herein, including during, before, and/or after any of the process steps disclosed herein. The one or more fire resistance compositions may include expandable graphite, vermiculite, perlite, or a combination thereof. Notably, one or more fire resistance compositions may be incorporated in one or more gypsum slurries (e.g., a first gypsum slurry, a second gypsum slurry, a third gypsum slurry) and/or one or more gypsum core layers (e.g., a first gypsum core layer, a second gypsum core layer, a third gypsum core layer). Generally, a fire resistance composition may be present between the first facing material and the gypsum slurry and/or gypsum core and/or may be present between the second facing material and the gypsum slurry and/or gypsum core. In general, a fire resistance composition may be applied by spraying, brushing, curtain coating, and/or roll coating.

In one aspect, the application of a fire resistance composition may result in the penetration and/or embedment of a fire resistance composition and/or any components thereof in one or more of the facing materials (e.g., first facing material, second facing material) of a gypsum panel and/or wallboard assembly. Notably, the penetration and/or embedment of a fire resistance composition and/or any components thereof may result in improved fire resistance characteristics and properties. Generally, if the fire resistance composition is applied via spraying, the intensity and/or angle of the spraying and the distance of the spraying mechanism to the facing material may affect the depth of penetration of the fire resistance composition and/or any components thereof.

Generally, a fire resistance composition and/or any components thereof may penetrate at least a portion of the thickness of a respective facing material (e.g., first facing material, second facing material) of a gypsum panel and/or a wallboard assembly. Notably, the fire resistance composition and/or any components thereof may penetrate a respective facing material (e.g., first facing material, second facing material) by about 0% to about 100% of the thickness of the respective facing material, such as about 0% or more, such as about 10% or more, such as about 20% or more, such as about 30% or more, such as about 40% or more, such as about 50% or more, such as about 60% or more, such as about 70% or more, such as about 80% or more, such as about 90% or more, such as about 100% or less, such as about 90% or less, such as about 80% or less, such as about 70% or less, such as about 60% or less, such as about 50% or less, such as about 40% or less, such as about 30% or less, such as about 20% or less, such as about 10% or less.

In general, the composition of the gypsum core is not necessarily limited and may include any additives as known in the art. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants (e.g., waxes, silicones, siloxanes, etc.), fillers (e.g., glass spheres, glass fibers), natural and synthetic fibers (e.g. cellulosic fibers, microfibrillated fibers, nanocellulosic fibers, etc.), acids (e.g., boric acid), secondary phosphates (e.g., condensed phosphates or orthophosphates including trimetaphosphates, polyphosphates, and/or cyclophosphates, etc.) and/or other phosphate derivatives (e.g., fluorophosphates, etc.), natural and synthetic polymers, starches (e.g., pregelatinized starch, non-pregelatinized starch, and/or a modified starch, such as an acid modified starch), sound dampening polymers (e.g., viscoelastic polymers/glues, such as those including an acrylic/acrylate polymer, etc.; polymers with low glass transition temperature, etc.), and mixtures thereof. In general, it should be understood that the types and amounts of such additives are not necessarily limited by the present invention.

Each additive of the gypsum core may be present in the gypsum core in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

In some aspects, the gypsum core is sandwiched by facing materials. The facing material may be any facing material as generally employed in the art. For instance, the facing material may be a paper facing material, a fibrous (e.g., glass fiber) mat facing material, or a polymeric facing material. In general, the first facing material and the second facing material may be the same type of material. Alternatively, the first facing material may be one type of material while the second facing material may be a different type of material.

In one embodiment, the facing material may include a paper facing material. For instance, both the first and second facing materials may be a paper facing material. Alternatively, in another embodiment, the facing material may be a glass mat facing material. For instance, both the first and second facing materials may be a glass mat facing material. In a further embodiment, the facing material may be a polymeric facing material. For instance, both the first and second facing materials may be a polymeric facing material. In another further embodiment, the facing material may be a metal facing material (e.g., an aluminum facing material). For instance, both the first and second facing materials may be a metal facing material (e.g., an aluminum facing material).

The glass mat facing material in one embodiment may be coated. However, in one particular embodiment, the glass mat facing material may not have a coating, such as a coating that is applied to the surface of the mat.

In general, a gypsum panel formed in accordance with the present disclosure may be formed from a method as disclosed herein. For instance, in the method of making a gypsum panel, a first facing material may be provided wherein the first facing material has a first facing material surface and a second facing material surface opposite the first facing material surface. The first facing material may be conveyed on a conveyor system (i.e., a continuous system for continuous manufacture of gypsum panel). Thereafter, a gypsum slurry may be provided or deposited onto the first facing material in order to form and provide a gypsum core. Next, a second facing material may be provided onto the gypsum slurry. The first facing material, the gypsum core, and the second facing material may then be dried simultaneously. Next, the first facing material, the gypsum core, and the second facing material may be cut such that the first facing material, the gypsum core, and the second facing material form a gypsum panel.

In general, the composition of the gypsum slurry is not necessarily limited and may be any generally known in the art. Generally, in one embodiment, the gypsum core is made from a gypsum slurry including at least stucco and water.

In general, stucco may be referred to as calcined gypsum or calcium sulfate hemihydrate. The calcined gypsum may be from a natural source, a synthetic source, and/or reclaim and is thus not necessarily limited by the present invention. In addition to the stucco, the gypsum slurry may also contain some calcium sulfate dihydrate or calcium sulfate anhydrite. If calcium sulfate dihydrate is present, the hemihydrate is present in an amount of at least 50 wt. %, such as at least 60 wt. %, such as at least 70 wt. %, such as at least 80 wt. %, such as at least 85 wt. %, such as at least 90 wt. %, such as at least 95 wt. %, such as at least 98 wt. %, such as at least 99 wt. % based on the weight of the calcium sulfate hemihydrate and the calcium sulfate dihydrate. Furthermore, the calcined gypsum may be anhydrite (e.g., AII, AIII), α-hemihydrate, β-hemihydrate, or a mixture thereof.

In addition to the stucco, the gypsum slurry may also contain other cementitious materials. These cementitious materials may include calcium sulfate anhydrite, land plaster, cement, fly ash, or any combination thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material.

As indicated above, the gypsum slurry may include water. Water may be employed for fluidity and also for rehydration of the gypsum to allow for setting.

The weight ratio of the water to the stucco may be 0.1 or more, such as 0.2 or more, such as 0.2 or more, such as 0.3 or more, such as 0.4 or more, such as 0.5 or more, such as 0.6 or more, such as 0.7 or more. The water to stucco weight ratio may be 4 or less, such as 3.5 or less, such as 3 or less, such as 2.5 or less, such as 2 or less, such as 1.7 or less, such as 1.5 or less, such as 1.4 or less, such as 1.3 or less, such as 1.2 or less, such as 1.1 or less, such as 1 or less, such as 0.9 or less, such as 0.85 or less, such as 0.8 or less, such as 0.75 or less, such as 0.7 or less, such as 0.6 or less, such as 0.5 or less, such as 0.4 or less, such as 0.35 or less, such as 0.3 or less, such as 0.25 or less, such as 0.2 or less.

In addition to the stucco and the water, the gypsum slurry may also include any other conventional additives as known in the art. In this regard, such additives are not necessarily limited by the present invention. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants (e.g., waxes, silicones, siloxanes, etc.), fillers (e.g., glass spheres, glass fibers), natural and synthetic fibers (e.g. cellulosic fibers, microfibrillated fibers, nanocellulosic fibers, etc.), acids (e.g., boric acid), secondary phosphates (e.g., condensed phosphates or orthophosphates including trimetaphosphates, polyphosphates, and/or cyclophosphates, etc.) and/or other phosphate derivatives (e.g., fluorophosphates, etc.), natural and synthetic polymers, starches (e.g., pregelatinized starch, non-pregelatinized starch, and/or a modified starch, such as an acid modified starch), sound dampening polymers (e.g., viscoelastic polymers/glues, such as those including an acrylic/acrylate polymer, etc.; polymers with low glass transition temperature, etc.), and mixtures thereof. In general, it should be understood that the types and amounts of such additives are not necessarily limited by the present invention.

Each additive of the gypsum slurry may be present in the gypsum slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

The foaming agent may be one generally utilized in the art. For instance, the foaming agent may include an alkyl sulfate, an alkyl ether sulfate, or a mixture thereof. In one embodiment, the foaming agent includes an alkyl sulfate. In another embodiment, the foaming agent includes an alkyl ether sulfate. In a further embodiment, the foaming agent includes an alkyl sulfate without an alkyl ether sulfate. In an even further embodiment, the foaming agent includes a mixture of an alkyl sulfate and an alkyl ether sulfate. When a mixture is present, the alkyl ether sulfate may be present in an amount of 30 wt. % or less, such as 20 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less based on the combined weight of the alkyl sulfate and the alkyl ether sulfate. In addition, the alkyl ether sulfate may be present in an amount of 0.01 wt. % or more, such as 0.1 wt. % or more, such as 0.2 wt. % or more, such as 0.3 wt. % or more, such as 0.5 wt. % or more, such as 1 wt. % or more, such as 1.5 wt. % or more, such as 2 wt. % or more, such as 2.5 wt. % or more, such as 3 wt. % or more, such as 4 wt. % or more, such as 5 wt. % or more, such as 10 wt. % or more, such as 20 wt. % or more, based on the combined weight of the alkyl sulfate and the alkyl ether sulfate.

As indicated, the foaming agent may include a combination of an alkyl sulfate and an alkyl ether sulfate. In this regard, the weight ratio of the alkyl sulfate to the alkyl ether sulfate may be 2 or more, such as 4 or more, such as 5 or more, such as 10 or more, such as 15 or more, such as 20 or more, such as 25 or more, such as 30 or more, such as 40 or more, such as 50 or more, such as 60 or more, such as 70 or more, such as 80 or more, such as 90 or more, such as 95 or more. The weight ratio may be less than 100, such as 99 or less, such as 98 or less, such as 95 or less, such as 90 or less, such as 85 or less, such as 80 or less, such as 75 or less, such as 70 or less, such as 60 or less, such as 50 or less, such as 40 or less, such as 30 or less, such as 20 or less, such as 15 or less, such as 10 or less, such as 8 or less, such as 5 or less, such as 4 or less.

In another aspect, the alkyl ether sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl ether sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

Additionally, in one aspect, the alkyl sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

In one aspect, the foaming agent may include one or more foam stabilizers, such as ethoxylated glycerin. The one or more foam stabilizers may be present in the gypsum slurry and/or gypsum core in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less by weight of the foaming agent. The one or more foam stabilizers may be present in the gypsum slurry and/or gypsum core in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more by weight of the foaming agent.

By utilizing a soap, foaming agent, and/or foam as disclosed herein, the gypsum slurry may include bubbles or voids having a particular size. Such size may then contribute to the void structure in the gypsum panel and the resulting properties. In this regard, the gypsum slurry may have bubbles or voids having a median size of 50 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more, such as 1,000 microns or more. The gypsum slurry may have bubbles or voids having a median size of 1,400 microns or less, such as 1,300 microns or less, such as 1,200 microns or less, such as 1,100 microns or less, such as 1,000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 100 microns or less. Furthermore, while the aforementioned references a median size, it should be understood that in another embodiment, such size may also refer to an average size.

In one aspect, the foam may be provided in an amount of 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

The foam may comprise water and a foaming agent. In one aspect, the foaming agent may be provided in an amount of 0.05 lbs/MSF or more, such as 0.25 lbs/MSF or more, such as 0.5 lbs/MSF or more, such as 0.75 lbs/MSF or more, such as 1 lb/MSF or more, such as 2 lbs/MSF or more, such as 3 lbs/MSF or more, such as 4 lbs/MSF or more. The foaming agent may be provided in an amount of 5 lbs/MSF or less, such as 4 lbs/MSF or less, such as 3 lbs/MSF or less, such as 2 lbs/MSF or less, such as 1 lb/MSF or less, such as 0.5 lbs/MSF or less, such as 0.25 lbs/MSF or less. Further, in one aspect, the water utilized in the foam may be provided in an amount of 70 lbs/MSF or more, such as 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The water utilized in the foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

In one aspect, the foaming agent may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The foaming agent may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

In some aspects, the gypsum slurry and/or gypsum core may include a dispersant. The dispersant is not necessarily limited and may include any that can be utilized within the gypsum slurry. The dispersant may include carboxylates, sulfates, sulfonates, phosphates, mixtures thereof, etc.

In one embodiment, the dispersant may include a carboxylate, such as a carboxylate ether and in particular a polycarboxylate ether or a carboxylate ester and in particular a polycarboxylate ester.

In a further embodiment, the dispersant may include a sulfonate, such as a naphthalene sulfonate, a naphthalene sulfonate formaldehyde condensate, a sodium naphthalene sulfonate formaldehyde condensate, a lignosulfonate, a melamine formaldehyde condensate, or a mixture thereof.

In another embodiment, the dispersant may include a phosphate. For instance, the phosphate dispersant may be a polyphosphate dispersant, such as sodium trimetaphosphate, sodium tripolyphosphate, potassium tripolyphosphate, tetrasodium pyrophosphate, tetrapotassium pyrophosphate, tetrapotassium pyrophosphate, or a mixture thereof. In one embodiment, the polyphosphate dispersant may be sodium trimetaphosphate. In one embodiment, the phosphate may be sodium monofluorophosphate.

In this regard, the dispersant may include a sulfonate, a polycarboxylate ether, a polycarboxylate ester, or a mixture thereof. In one embodiment, the dispersant may include a sulfonate. In another embodiment, the dispersant may include a polycarboxylate ether. In a further embodiment, the dispersant may include a polycarboxylate ester.

In one aspect, the dispersant may be provided in an amount of 0.01 lbs/MSF or more, such as 0.5 lbs/MSF or more, such as 1 lb/MSF or more, such as 2 lbs/MSF or more, such as 5 lbs/MSF or more, such as 8 lbs/MSF or more, such as 10 lbs/MSF or more, such as 15 lbs/MSF or more, such as 20 lbs/MSF or more, such as 25 lbs/MSF or more, such as 30 lbs/MSF or more, such as 35 lbs/MSF or more. The dispersant may be provided in an amount of 40 lbs/MSF or less, such as 35 lbs/MSF or less, such as 30 lbs/MSF or less, such as 25 lbs/MSF or less, such as 20 lbs/MSF or less, such as 15 lbs/MSF or less, such as 10 lbs/MSF or less, such as 8 lbs/MSF or less, such as 5 lbs/MSF or less, such as 2 lbs/MSF or less, such as 1 lb/MSF or less.

In one aspect, the dispersant may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The dispersant may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

In some aspects, the gypsum slurry and/or gypsum core may include one or more surfactants. In general, the surfactant may be an anionic surfactant, a cationic surfactant, a non-ionic surfactant, a fluorinated surfactant, a silicon surfactant, or a mixture thereof. Generally, a surfactant may be in the form of a solid, a liquid, or a combination thereof.

As indicated above, in one embodiment, the surfactant may include an anionic surfactant. In general, anionic surfactants include those having one or more negatively charged functional groups. For instance, the anionic surfactant may include an alkali metal or ammonium salts of alkyl, aryl or alkylaryl sulfonates, sulfates, or a mixture thereof. In some aspects, the anionic surfactant may include ammonium lauryl sulfate, sodium lauryl sulfate, sodium octylphenol glycolether sulfate, sodium laureth sulfate, sodium myreth sulfate, sodium dodecylbenzene sulfonate, perfluorobutane sulfonate, dodecyl benzene sulfonate, alpha-olefin sulfonate, sodium lauryldiglycol sulfate, ammonium tritertiarybutyl phenol and penta- and octa-glycol sulfonates, sulfosuccinate salts such as disodium ethoxylated nonylphenol half ester of sulfosuccinic acid, disodium n-octyldecyl sulfosuccinate, sodium dioctyl sulfosuccinate, alpha olefin sulfonate, and mixtures thereof. Other examples include a C₈-C₂₂ alkyl fatty acid salt of an alkali metal, alkaline earth metal, ammonium, alkyl substituted ammonium, for example, isopropylamine salt, or alkanolammonium salt, a C₈-C₂₂ alkyl fatty acid ester, a C₈-C₂₂ alkyl fatty acid ester salt, and alkyl ether carboxylates. Further, the anionic surfactant may include a phosphate (alkyl-aryl ether phosphates, alkyl ether phosphates, etc.), a phosphite, a phosphonate, a carboxylate (e.g., sodium stearate, etc.), or a mixture thereof.

In one particular embodiment, the anionic surfactant may include a water-soluble salt, particularly an alkali metal salt, of an organic sulfur reaction product having in their molecular structure an alkyl radical containing from about 8 to 22 carbon atoms and a radical selected from the group consisting of sulfonic and sulfuric acid ester radicals. Organic sulfur based anionic surfactants include the salts of C₁₀-C₁₆ alkylbenzene sulfonates, C₁₀-C₂₂ alkane sulfonates, C₁₀-C₂₂ alkyl ether sulfates, C₁₀-C₂₂ alkyl sulfates, C₄-C₁₀ dialkylsulfosuccinates, C₁₀-C₂₂ acyl isothionates, alkyl diphenyloxide sulfonates, alkyl naphthalene sulfonates, C₁₀-C₂₀ alpha olefin sulfonates, and 2-acetamido hexadecane sulfonates. In one aspect, the anionic surfactant may include C₆-C₁₂ linear and/or branched alkyl sulfates and/or C₆-C₁₂ linear and/or branched alkyl ether sulfates. Organic phosphate based anionic surfactants include organic phosphate esters such as complex mono- or diester phosphates of hydroxyl-terminated alkoxide condensates, or salts thereof. Included in the organic phosphate esters are phosphate ester derivatives of polyoxyalkylated alkylaryl phosphate esters, of ethoxylated linear alcohols and ethoxylates of phenol. Particular examples of anionic surfactants include a polyoxyethylene alkyl ether sulfuric ester salt, a polyoxyethylene alkylphenyl ether sulfuric ester salt, polyoxyethylene styrenated alkylether ammonium sulfate, polyoxymethylene alkylphenyl ether ammonium sulfate, and the like, and mixtures thereof. For instance, the anionic surfactant may include a polyoxyethylene alkyl ether sulfuric ester salt, a polyoxyethylene alkylphenyl ether sulfuric ester salt, or a mixture thereof. In some aspects, the anionic surfactant may include sulfated alkanolamide, glyceride sulfate, or a mixture thereof.

As indicated above, in one embodiment, the surfactant may include a non-ionic surfactant. In one aspect, the nonionic surfactant may be an amine oxide. In one aspect, the nonionic surfactant may be an ethoxylate. For instance, the nonionic surfactant may be an ethoxylated fatty alcohol, a linear alcohol ethoxylate (e.g., narrow-range ethoxylate, octaethylene glycol monododecyl ether, pentaethylene glycol monododecyl ether, etc.), an alkylphenol ethoxylate (e.g., a nonoxynol, octylphenol ethoxylate, etc.), a fatty acid ethoxylate, an ethoxylated fatty ester, or an ethoxylated amine. In some aspects, the nonionic surfactant may be and/or include fatty acid amides (e.g., polyethoxylated tallow amine, cocamide monoethanolamine, cocamide diethanolamine, etc.), fatty acid esters of glycerol (e.g., glycerol monostearate, glyercol monolaurate, etc.), fatty acid esters of sorbitol (e.g., sorbitan monolaurate, sorbitan monostearate, sorbitan tristearate, etc.), alkyl polyglycosides (e.g., decyl glucoside, lauryl glucoside, octyl glucoside, etc.), block copolymers of polyethylene glycol and polypropylene glycol, glycerol alkyl esters, alkyl polyglucosides, polyoxyethylene glycol octylphenol ethers, sorbitan alkyl esters, polyoxyethylene glycol sorbitan alkyl esters, and mixtures thereof. For instance, the non-ionic surfactant may include a polyethylene oxide condensate of an alkyl phenol (e.g., the condensation product of an alkyl phenol having an alkyl group containing from 6 to 12 carbon atoms in either a straight chain or branched chain configuration, with ethylene oxide (e.g., present in amounts equal to 1 to 40 moles)). The alkyl substituent may be derived, for example, from polymerized propylene, di-isobutylene, octane or nonene. Other examples include dodecylphenol condensed with 12 moles of ethylene oxide per mole of phenol; dinonylphenol condensed with 5 moles of ethylene oxide per mole of phenol; nonylphenol condensed with 9 moles of ethylene oxide per mole of nonylphenol and di-iso-octylphenol condensed with 5 moles of ethylene oxide. The non-ionic surfactant may be a condensation product of a primary or secondary aliphatic alcohol having from 8 to 24 carbon atoms, in either straight chain or branched chain configuration, with from 1 to about 40 moles of alkylene oxide per mole of alcohol. The non-ionic surfactant may include a compound formed by condensing ethylene oxide with a hydrophobic base formed by the condensation of propylene oxide with propylene glycol (e.g., Pluronics). In one embodiment, the surfactant may be a silicon surfactant such as a polyether-modified siloxane.

In one embodiment, the surfactant may include a cationic surfactant. For instance, the surfactant may include a cationic surfactant such as water-soluble quaternary ammonium compounds, polyammonium salts, a polyoxyethylene alkylamine and the like. In some aspects, the surfactant may include a cationic surfactant such as a quaternary ammonium salt (e.g., cetrimonium bromide, cetylpyridinium chloride, benzalkonium chloride, benzethonium chloride, dimethyldioctadecylammonium chloride, and dioctadecyldimethylammonium bromide, etc.).

Notably, gypsum slurry and/or gypsum core may include a starch. The starch may be one generally utilized in the art. Such starch may be combined with the stucco and water. In this regard, such starch may be present in the gypsum slurry as well as the resulting gypsum core and gypsum panel. In one aspect, one or more components of a gypsum panel may be free of starch. For instance, the gypsum core and/or gypsum slurry may be free of starch. In one aspect, a gypsum panel formed in accordance with the present disclosure may be free of starch.

The starch may be a corn starch, a wheat starch, a milo starch, a potato starch, a rice starch, an oat starch, a barley starch, a cassava starch, a tapioca starch, a pea starch, a rye starch, an amaranth starch, or other commercially available starch. For example, in one embodiment, the starch may be a corn starch. In another embodiment, the starch may be a wheat starch. In an even further embodiment, the starch may be a milo starch.

Furthermore, the starch may be an unmodified starch or a modified starch. In one embodiment, the starch may be a modified starch. In another embodiment, the starch may be an unmodified starch. In an even further embodiment, the starch may be a mixture of a modified starch and an unmodified starch.

As indicated above, in one embodiment, the starch may be an unmodified starch. For instance, the starch may be a pearl starch (e.g., an unmodified corn starch). In addition, in one embodiment, the starch may also be a non-migrating starch. Also, with respect to gelatinization, the starch may be a non-pregelatinized starch.

As also indicated above, in another embodiment, the starch may be a modified starch. Such modification may be any as typically known in the art and is not necessarily limited. For instance, the modification may be via a physical, enzymatic, or chemical treatment. In one embodiment, the modification may be via a physical treatment. In another embodiment, the modification may be via an enzymatic treatment. In a further embodiment, the modification may be via a chemical treatment. The starch may be treated using many types of reagents. For example, the modification can be conducted using various chemicals, such as inorganic acids (e.g., hydrochloric acid, phosphorous acid or salts thereof, etc.), peroxides (e.g., sodium peroxide, potassium peroxide, hydrogen peroxide, etc.), anhydrides (e.g., acetic anhydride), etc. to break down the starch molecule.

In this regard, in one embodiment, the starch may be a pregelatinized starch, an acid-modified (or hydrolyzed) starch, an extruded starch, an oxidized starch, an oxyhydrolyzed starch, an ethoxylated starch, an ethylated starch, an acetylated starch, a mixture thereof, etc. For example, in one embodiment, the starch may be a pregelatinized starch. In another embodiment, the starch may be an acid-modified (or hydrolyzed) starch. In a further embodiment, the starch may be an extruded starch. In another embodiment, the starch may be an oxidized starch. In a further embodiment, the starch may be an oxyhydrolyzed starch. In another further embodiment, the starch may be an ethoxylated starch. In another embodiment, the starch may be an ethylated starch. In a further embodiment, the starch may be an acetylated starch.

In one embodiment, the starch may be a pregelatinized starch. In this regard, the starch may have been exposed to water and heat for breaking down a certain degree of intermolecular bonds within the starch. As an example and without intending to be limited by theory, during heating, water is absorbed into the amorphous regions of the starch thereby allowing it to swell. Then amylose chains may begin to dissolve resulting in a decrease in the crystallinity and an increase in the amorphous form of the starch.

In another embodiment, the starch may be an acid-modified starch. Such acid modification can be conducted using various chemicals, such as inorganic acids (e.g., hydrochloric acid, phosphorous acid or salts thereof, etc.) to break down the starch molecule. Furthermore, by utilizing acid-modification, the starch may result in a low thinned starch, a medium thinned starch, or a high thinned starch. For example, a higher degree of modification can result in a lower viscosity starch while a lower degree of modification can result in a higher viscosity starch. The degree of modification and resulting viscosity may also affect the degree of migration of the starch. For instance, when presented within the core of the gypsum panel, a higher degree of modification and lower viscosity may provide a high migrating starch while a lower degree of modification and higher viscosity may provide a low migrating starch.

The starch may also have a particular gelling temperature. Without intending to be limited, this temperature is the point at which the intermolecular bonds of the starch are broken down in the presence of water and heat allowing the hydrogen bonding sites to engage more water. In this regard, the gelling temperature may be 60° C. or more, such as 80° C. or more, such as 100° C. or more. The gelling temperature may be 120° C. or less, such as 100° C. or less, such as 80° C. or less. In one embodiment, the aforementioned may refer to a peak gelling temperature.

As indicated above, the starch may have a particular gelling temperature. Without intending to be limited by theory, acid modification may provide a starch having a relatively lower gelling temperature. Meanwhile, without intending to be limited by theory, modifications of the hydroxyl group, such as by replacement via ethoxylation, ethylation, oxidation, or acetylation may provide a relatively lower gelling temperature or a reduction in gelling temperature. In this regard, in some embodiments, the starch may be acid-modified and chemically modified wherein the hydroxyl groups are substituted.

In one embodiment, the starch may be an extruded starch. For example, the extrusion may provide a thermomechanical process that can break the intermolecular bonds of the starch. Such extrusion may result in the gelatinization of starch due to an increase in the water absorption.

In another embodiment, the starch may be an oxidized starch. For example, the starch may be oxidized using various means known in the art. This may include, but is not limited to, chemical treatments utilizing oxidizing agents such as chlorites, chlorates, perchlorates, hypochlorites (e.g., sodium hypochlorite, etc.), peroxides (e.g., sodium peroxide, potassium peroxide, hydrogen peroxide, etc.), etc. In general, during oxidation, the molecules are broken down yielding a starch with a decreased molecular weight and a reduction in viscosity.

Also, it should be understood that the starch may include a combination of starches, such as any of those mentioned above. For instance, it should be understood that the starch may include more than one different starch. In addition, any combination of modifications may also be utilized to form the starch utilized according to the present invention.

In one aspect, the starch may be present in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 8 lbs/MSF or more, such as 10 lbs/MSF or more, such as 15 lbs/MSF or more, such as 20 lbs/MSF or more. The starch may be present in an amount of 50 lbs/MSF or less, such as 30 lbs/MSF or less, such as 25 lbs/MSF or less, such as 20 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less.

The manner in which the components (e.g., stucco, gypsum, water) for the gypsum slurry are combined is not necessarily limited. For instance, the gypsum slurry can be made using any method or device generally known in the art. In particular, the components of the slurry can be mixed or combined using any method or device generally known in the art. For instance, the components of the gypsum slurry may be combined in any type of device, such as a mixer and in particular a pin mixer. In this regard, the manner in which the components are incorporated into the gypsum slurry is not necessarily limited by the present invention. Such components may be provided prior to a mixing device, directly into a mixing device, in a separate mixing device, and/or even after the mixing device. For instance, the respective components may be provided prior to a mixing device. In another embodiment, the respective components may be provided directly into a mixing device. For instance, in one embodiment, the foaming agent or soap may be provided directly into the mixer. Alternatively, the respective components may be provided after the mixing device (such as to the canister or boot, using a secondary mixer, or applied directly onto the slurry after a mixing device) and may be added directly or as part of a mixture. Whether provided prior to, into, or after the mixing device, the components may be combined directly with another component of the gypsum slurry. In addition, whether providing the components prior to or after the mixing device or directly into the mixing device, the compound may be delivered as a solid, as a dispersion/solution, or a combination thereof.

Upon deposition of the gypsum slurry, the calcium sulfate hemihydrate reacts with the water to hydrate the calcium sulfate hemihydrate into a crystalline matrix of calcium sulfate dihydrate. In this respect, the stucco may convert into calcium sulfate dihydrate. Such reaction may allow for the gypsum to set and become firm thereby allowing for the panels to be cut at the desired length. In this regard, the method may comprise a step of reacting calcium sulfate hemihydrate with water to form calcium sulfate dihydrate or allowing the calcium sulfate hemihydrate to hydrate to calcium sulfate dihydrate. In this regard, the method may allow for the slurry to set to form a gypsum panel. In addition, during this process, the method may allow for drying of the gypsum slurry, in particular drying any free water instead of combined water of the gypsum slurry. Such drying may occur prior to the removal of any free moisture or water in a heating or drying device after a cutting step. Thereafter, the method may also comprise a step of cutting a continuous gypsum sheet into a gypsum panel. Then, after the cutting step, the method may comprise a step of supplying the gypsum panel to a heating or drying device to undergo a drying process. For instance, such a heating or drying device may be a kiln and may allow for removal of any free water. The temperature and time required for drying in a heating device is not necessarily limited by the present invention.

In one embodiment, the gypsum core may include a first gypsum core layer and a second gypsum core layer. The first gypsum core layer may be between the first facing material (i.e., front of the gypsum panel) and the second gypsum core layer. In addition, the first gypsum core layer may have a density greater than the second gypsum core layer. Accordingly, the first gypsum core layer may be formed using a gypsum slurry without the use of foam and/or a foaming agent or with a reduced amount of foam and/or a foaming agent, which may be utilized in forming the second gypsum core layer. In this regard, in one embodiment, the first gypsum core layer may have the same composition as the second gypsum core layer except that the second gypsum core layer may be formed using foam and/or a foaming agent or a greater amount of foam and/or a foaming agent.

In one embodiment, the gypsum core may also include a third gypsum core layer. The third gypsum core layer may be provided between the second gypsum core layer and a second facing material (i.e., back of the gypsum panel). Like the first gypsum core layer, the third gypsum core layer may also be a dense gypsum core layer. In particular, the third gypsum core layer may have a density greater than the second gypsum core layer. Accordingly, the third gypsum core layer may be formed using a gypsum slurry without the use of foam and/or a foaming agent or with a reduced amount of foam and/or a foaming agent, which may be utilized in forming the second gypsum core layer. In this regard, in one embodiment, the third gypsum core layer may have the same composition as the second gypsum core layer except that the second gypsum core layer may be formed using foam and/or a foaming agent or a greater amount of foam and/or a foaming agent.

When the gypsum core includes multiple gypsum core layers, the gypsum slurry may be deposited in multiple steps for forming the gypsum core. For instance, each gypsum core layer may require a separate deposition of gypsum slurry. In this regard, with a first gypsum core layer and a second gypsum core layer, a first gypsum slurry may be deposited followed by a second gypsum slurry. The first gypsum slurry and the second gypsum slurry may have the same composition except that the second gypsum slurry may include foam and/or a foaming agent or more foam and/or a foaming agent than the first gypsum slurry. In this regard, in one embodiment, the first gypsum slurry may not include foam and/or a foaming agent. Accordingly, the first gypsum slurry may result in a dense gypsum core layer, in particular a non-foamed gypsum core layer. Such gypsum core layer may have a density greater than the gypsum core layer formed from the second gypsum slurry, or foamed gypsum core layer.

Similarly, when the gypsum core includes three gypsum core layers, the gypsum slurry may be deposited in three steps for forming the gypsum core. For example, a first and second gypsum slurry may be deposited as indicated above and a third gypsum slurry may be deposited onto the second gypsum slurry. The third gypsum slurry and the second gypsum slurry may have the same composition except that the second gypsum slurry may include foam and/or a foaming agent or more foam and/or a foaming agent than the third gypsum slurry. In this regard, in one embodiment, the third gypsum slurry may not include foam and/or a foaming agent. Accordingly, the third gypsum slurry may result in a dense gypsum core layer, in particular a non-foamed gypsum core layer. Such gypsum core layer may have a density greater than the gypsum core layer formed from the second gypsum slurry, or foamed gypsum core layer.

The first gypsum core layer may have a thickness that is 0.5% or more, such as 1% or more, such as 2% or more, such as 3% or more, such as 4% or more, such as 5% or more, such as 10% or more, such as 15% or more than the thickness of the second (or foamed) gypsum core layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less the thickness of the second (or foamed) gypsum core layer. In one embodiment, such relationship may also be between the third gypsum core layer and the second gypsum core layer.

The density of the second (or foamed) gypsum core layer may be 0.5% or more, such as 1% or more, such as 2% or more, such as 3% or more, such as 4% or more, such as 5% or more, such as 10% or more, such as 15% or more the density of the first (or non-foamed) gypsum core layer. The density of the second (or foamed) gypsum core layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the first (or non-foamed) gypsum core layer. In one embodiment, such relationship may also be between the third gypsum core layer and the second gypsum core layer. In addition, in one embodiment, all of the gypsum core layers may have a different density.

In one embodiment, the gypsum panel may be processed such that any respective gypsum core layer may have an average void size of about 50 microns to about 1200 microns, such as about 50 microns or more, such as about 100 microns or more, such as about 150 microns or more, such as about 200 microns or more, such as about 250 microns or more, such as about 300 microns or more, such as about 350 microns or more, such as about 400 microns or more, such as about 450 microns or more, such as about 500 microns or more, such as about 600 microns or more, such as about 700 microns or more, such as about 800 microns or more. Generally, the average void size may be about 1200 microns or less, such as about 1100 microns or less, such as about 1000 microns or less, such as about 900 microns or less, such as about 800 microns or less, such as about 700 microns or less, such as about 600 microns or less, such as about 500 microns or less, such as about 400 microns or less, such as about 300 microns or less, such as about 200 microns or less, such as about 100 microns or less. In one embodiment, such core voids may reference any air voids due to voids generated from the use of a soap/foam. Furthermore, while the aforementioned references an average void size, it should be understood that in another embodiment, such size may also refer to a median void size.

The specific surface area of the gypsum core is not necessarily limited and may be from about 0.25 m²/g to about 15 m²/g, including all increments of 0.01 m²/g therebetween. For instance, the specific surface area may be 0.25 m²/g or more, such as 0.5 m²/g or more, such as 1 m²/g or more, such as 1.5 m²/g or more, such as 2 m²/g or more, such as 2.5 m²/g or more, such as 3 m²/g or more, such as 3.5 m²/g or more, such as 4 m²/g or more, such as 5 m²/g or more, such as 6 m²/g or more, such as 8 m²/g or more, such as 10 m²/g or more. The specific surface area of the gypsum core may be 15 m²/g or less, such as 10 m²/g or less, such as 8 m²/g or less, such as 6 m²/g or less, such as 4 m²/g or less, such as 3.5 m²/g or less, such as 3 m²/g or less, such as 2.5 m²/g or less, such as 2 m²/g or less, such as 1.5 m²/g or less, such as 1 m²/g or less.

The thickness of the gypsum panel, and in particular, the gypsum core, is not necessarily limited and may be from about 0.25 inches to about 1 inch. For instance, the thickness may be at least ¼ inches, such as at least 5/16 inches, such as at least ⅜ inches, such as at least ½ inches, such as at least ⅝ inches, such as at least ¾ inches, such as at least 1 inch. In this regard, the thickness may be about any one of the aforementioned values. For instance, the thickness may be about ¼ inches. Alternatively, the thickness may be about ⅜ inches. In another embodiment, the thickness may be about ½ inches. In a further embodiment, the thickness may be about ⅝ inches. In another further embodiment, thickness may be about 1 inch. In addition, at least two gypsum panels may be combined to create another gypsum panel, such as a composite gypsum panel. For example, at least two gypsum panels having a thickness of about 5/16 inches each may be combined or sandwiched to create a gypsum panel having a thickness of about ⅝ inches. While this is one example, it should be understood that any combination of gypsum panels may be utilized to prepare a sandwiched gypsum panel. With regard to the thickness, the term “about” may be defined as within 10%, such as within 5%, such as within 4%, such as within 3%, such as within 2%, such as within 1%. However, it should be understood that the present invention is not necessarily limited by the aforementioned thicknesses.

In addition, the panel weight of the gypsum panel is not necessarily limited. For instance, the gypsum panel may have a panel weight of 500 lbs/MSF or more, such as about 600 lbs/MSF or more, such as about 700 lbs/MSF or more, such as about 800 lbs/MSF or more, such as about 900 lbs/MSF or more, such as about 1000 lbs/MSF or more, such as about 1100 lbs/MSF or more, such as about 1200 lbs/MSF or more, such as about 1300 lbs/MSF or more, such as about 1400 lbs/MSF or more, such as about 1500 lbs/MSF or more. The panel weight may be about 7000 lbs/MSF or less, such as about 6000 lbs/MSF or less, such as about 5000 lbs/MSF or less, such as about 4000 lbs/MSF or less, such as about 3000 lbs/MSF or less, such as about 2500 lbs/MSF or less, such as about 2000 lbs/MSF or less, such as about 1800 lbs/MSF or less, such as about 1600 lbs/MSF or less, such as about 1500 lbs/MSF or less, such as about 1400 lbs/MSF or less, such as about 1300 lbs/MSF or less, such as about 1200 lbs/MSF or less. Such panel weight may be a dry panel weight such as after the panel leaves the heating or drying device (e.g., kiln).

In addition, the gypsum panel may have a density of about 15 pcf or more, such as about 20 pcf or more, such as about 25 pcf or more, such as about 28 pcf or more, such as about 30 pcf or more, such as about 33 pcf or more, such as about 35 pcf or more, such as about 38 pcf or more, such as about 40 pcf or more, such as about 43 pcf or more, such as about 45 pcf or more, such as about 48 pcf or more. The panel may have a density of about 60 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20 pcf or less, such as about 18 pcf or less.

The gypsum panel may have a certain nail pull resistance, which generally is a measure of the force required to pull a gypsum panel off a wall by forcing a fastening nail through the panel. The values obtained from the nail pull test generally indicate the maximum stress achieved while the fastener head penetrates through the panel surface and core. In this regard, the gypsum panel exhibits a nail pull resistance of at least about 25 lb_{f}, such as at least about 30 pounds, such as at least about 35 lb_{f}, such as at least about 40 lb_{f}, such as at least about 45 lb_{f}, such as at least about 50 lb_{f}, such as at least about 55 lb_{f}, such as at least about 60 lb_{f}, such as at least about 65 lb_{f}, such as at least about 70 lb_{f}, such as at least about 75 lb_{f}, such as at least about 77 lb_{f}, such as at least about 80 lb_{f}, such as at least about 85 lb_{f}, such as at least about 90 lb_{f}, such as at least about 95 lb_{f}, such as at least about 100 lb_{f} as tested according to ASTM C473-19 and/or ASTM C1396-17. The nail pull resistance may be about 400 lb_{f} or less, such as about 300 lb_{f} or less, such as about 200 lb_{f} or less, such as about 150 lb_{f} or less, such as about 140 lb_{f} or less, such as about 130 lb_{f} or less, such as about 120 lb_{f} or less, such as about 110 lb_{f} or less, such as about 105 lb_{f} or less, such as about 100 lb_{f} or less, such as about 95 lb_{f} or less, such as about 90 lb_{f} or less, such as about 85 lb_{f} or less, such as about 80 lb_{f} or less as tested according to ASTM C473-19 and/or ASTM C1396-17. Such nail pull resistance may be based upon the thickness of the gypsum panel. For instance, when conducting a test, such nail pull resistance values may vary depending on the thickness of the gypsum panel. As an example, the nail pull resistance values above may be for a ⅝ inch panel. However, it should be understood that instead of a ⅝ inch panel, such nail pull resistance values may be for any other thickness gypsum panel as mentioned herein.

The gypsum panel may have a certain compressive strength. For instance, the compressive strength may be about 150 psi or more, such as about 200 psi or more, such as about 250 psi or more, such as about 300 psi or more, such as about 350 psi or more, such as about 375 psi or more, such as about 400 psi or more, such as about 500 psi or more as tested according to ASTM C473-19. The compressive strength may be about 3000 psi or less, such as about 2500 psi or less, such as about 2000 psi or less, such as about 1700 psi or less, such as about 1500 psi or less, such as about 1300 psi or less, such as about 1100 psi or less, such as about 1000 psi or less, such as about 900 psi or less, such as about 800 psi or less, such as about 700 psi or less, such as about 600 psi or less, such as about 500 psi or less. Such compressive strength may be based upon the density and thickness of the gypsum panel. For instance, when conducting a test, such compressive strength values may vary depending on the thickness of the gypsum panel. As an example, the compressive strength values above may be for a ⅝ inch panel. However, it should be understood that instead of a ⅝ inch panel, such compressive strength values may be for any other thickness gypsum panel as mentioned herein.

In addition, the gypsum panel may have a core hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f} as tested according to ASTM C1396-17. The gypsum panel may have a core hardness of 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396-17. In addition, the gypsum panel may have an end hardness according to the aforementioned values. Such core hardness may be based upon the thickness of the gypsum panel. For instance, when conducting a test, such core hardness values may vary depending on the thickness of the gypsum panel. As an example, the core hardness values above may be for a ⅝ inch panel. However, it should be understood that instead of a ⅝ inch panel, such core hardness values may be for any other thickness gypsum panel as mentioned herein.

In addition, the gypsum panel may have an edge hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f}, such as at least about 24 lb_{f}, such as at least about 28 lb_{f}, such as at least about 30 lb_{f}, such as at least about 33 lb_{f} as tested according to ASTM C1396-17 and ASTM C473-19. The gypsum panel may have an edge hardness of about 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396-17 and ASTM C473-19. Such edge hardness may be based upon the thickness of the gypsum panel. For instance, when conducting a test, such edge hardness values may vary depending on the thickness of the gypsum panel. As an example, the edge hardness values above may be for a ⅝ inch panel. However, it should be understood that instead of a ⅝ inch panel, such edge hardness values may be for any other thickness gypsum panel as mentioned herein.

In addition, it may also be desired to have an effective bond between the facing material and the gypsum core. Typically, a humidified bond test is performed for 2 hours in a humidity chamber at 90° F. and 90% humidity. In this test, after exposure, the facing material is removed to determine how much remains on the gypsum panel. The percent coverage (or surface area) can be determined using various optical analytical techniques. In this regard, the facing material may cover 100% or less, such as less than 90%, such as less than 80%, such as less than 70%, such as less than 60%, such as less than 50%, such as less than 40%, such as less than 30%, such as less than 25%, such as less than 20%, such as less than 15%, such as less than 10%, such as less than 9%, such as less than 8% of the surface area of the gypsum core upon conducting the test. Such percentage may be for a face of the gypsum panel. Alternatively, such percentage may be for a back of the gypsum panel. Further, such percentages may apply to the face and the back of the gypsum panel. In addition, such values may be for an average of at least 3 gypsum panels, such as at least 5 gypsum panels.

Also, it may be desired to have a particular humidified deflection based on exposure in an atmosphere of 90° F.±3° F. and 90%±3% relative humidity for 48 hours. For instance, the humidified deflection may be 0.1 inches or less, such as 0.08 inches or less, such as 0.06 inches or less, such as 0.05 inches or less, such as 0.04 inches or less, such as 0.03 inches or less, such as 0.02 inches or less, such as 0.01 inches or less, such as 0.005 inches or less. The humified deflection may be 0 inches or more, such as 0.0001 inches or more, such as 0.0005 inches or more, such as 0.001 inches or more, such as 0.003 inches or more, such as 0.005 inches or more, such as 0.008 inches or more, such as 0.01 inches or more, such as 0.015 inches or more. Such values may be for an average of at least 3 gypsum panels.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A wallboard assembly comprising:
a gypsum panel comprising a gypsum core and at least one facing material; and
two or more fasteners, the two or more fasteners comprising one or more field fasteners and one or more perimeter fasteners, wherein at least two adjacent fasteners of the two or more fasteners are spaced from each other by a distance of greater than 12 inches on center;
wherein the wallboard assembly has a fire rating of at least about 50 minutes when tested in accordance with the time-temperature curve of ASTM standard E119-16a and at least one of V438, U465, V488, or W469 Underwriters Laboratories, Inc. assemblies.

2. The wallboard assembly of claim 1, wherein the at least two adjacent fasteners of the two or more fasteners are spaced from each other by a distance of about 14 inches on center or more.

3. The wallboard assembly of claim 1, wherein the at least two adjacent fasteners of the two or more fasteners are spaced from each other by a distance of about 16 inches on center or more.

4. The wallboard assembly of claim 1, wherein at least one perimeter fastener of the one or more perimeter fasteners perpendicularly corresponds to at least one field fastener of the one or more field fasteners.

5. The wallboard assembly of claim 4, wherein the at least one field fastener and the perpendicularly corresponding perimeter fastener are adjacent and are spaced from each other by a distance of about 12 inches on center or more.

6. The wallboard assembly of claim 4, wherein the at least one field fastener and the perpendicularly corresponding perimeter fastener are adjacent and are spaced from each other by a distance of about 14 inches on center or more.

7. The wallboard assembly of claim 1, wherein the one or more field fasteners are spaced at regular intervals.

8. The wallboard assembly of claim 1, wherein the one or more field fasteners form one or more field fastener rows, the one or more field fastener rows being in-line.

9. The wallboard assembly of claim 1, wherein the one or more perimeter fasteners form one or more perimeter fastener rows, the one or more perimeter fastener rows being in-line.

10. The wallboard assembly of claim 1, wherein the one or more field fasteners form one or more field fastener rows, the one or more field fastener rows being in-line, wherein the one or more perimeter fasteners form one or more perimeter fastener rows, the one or more perimeter fastener rows being in-line.

11. The wallboard assembly of claim 10, wherein the one or more field fastener rows and the one or more perimeter fastener rows are spaced by a distance of about 14 inches or more.

12. The wallboard assembly of claim 10, wherein at least one perimeter fastener row of the one or more perimeter fastener rows and a first field fastener row of the one or more field fastener rows are spaced by a distance of 14 inches or more, wherein the at least one perimeter fastener row and a second field fastener row of the one or more field fastener rows are spaced by a distance of about 16 inches or more.

13. The wallboard assembly of claim 12, wherein the first field fastener row and the second field fastener row are spaced by a distance of about 4 inches or more.

14. The wallboard assembly of claim 1, wherein the one or more perimeter fasteners form two perimeter fastener rows, the two perimeter fastener rows including a first perimeter fastener row and a second perimeter fastener row.

15. The wallboard assembly of claim 14, wherein the first perimeter fastener row and the second perimeter fastener row are spaced by a distance of about 24 inches or more.

16. The wallboard assembly of claim 14, wherein the first perimeter fastener row and the second perimeter fastener row are spaced by a distance of about 32 inches or more.

17. A wallboard assembly comprising:
a gypsum panel comprising a gypsum core and at least one facing material; and
two or more fasteners, the two or more fasteners comprising one or more field fasteners and one or more perimeter fasteners, the one or more field fasteners and the one or more perimeter fasteners having on center values within a 12 inch on center range or less, wherein at least two adjacent fasteners of the two or more fasteners are spaced from each other by a distance of greater than 12 inches on center;
wherein the wallboard assembly has a fire rating of at least about 50 minutes when tested in accordance with the time-temperature curve of ASTM standard E119-16a and at least one of V438, U465, V488, or W469 Underwriters Laboratories, Inc. assemblies.

18. The wallboard assembly of claim 17, wherein:
the at least two adjacent fasteners of the two or more fasteners are spaced from each other by a distance of about 16 inches on center or more;
the one or more field fasteners form one or more field fastener rows, the one or more field fastener rows being in-line and the one or more perimeter fasteners form one or more perimeter fastener rows, the one or more perimeter fastener rows being in-line; and
at least one perimeter fastener row of the one or more perimeter fastener rows and the first field fastener row are spaced by a distance of 14 inches or more, wherein the at least one perimeter fastener row and the second field fastener row are spaced by a distance of about 16 inches or more.

19. A wallboard assembly comprising:
a gypsum panel comprising a gypsum core and at least one facing material; and
two or more fasteners, the two or more fasteners comprising one or more field fasteners and one or more perimeter fasteners, wherein at least one field fastener is spaced from all of the perimeter fasteners by a distance of greater than 12 inches;
wherein the wallboard assembly has a fire rating of at least about 50 minutes when tested in accordance with the time-temperature curve of ASTM standard E119-16a and at least one of V438, U465, V488, or W469 Underwriters Laboratories, Inc. assemblies.

20. The wallboard assembly of claim 19, wherein:
the at least two adjacent fasteners of the two or more fasteners are spaced from each other by a distance of about 16 inches on center or more;
the one or more field fasteners form one or more field fastener rows, the one or more field fastener rows being in-line and the one or more perimeter fasteners form one or more perimeter fastener rows, the one or more perimeter fastener rows being in-line; and
at least one perimeter fastener row of the one or more perimeter fastener rows and the first field fastener row are spaced by a distance of 14 inches or more, wherein the at least one perimeter fastener row and the second field fastener row are spaced by a distance of about 16 inches or more.
